(19) United States
(12) Patent Application Publication
(10) Pub. No.: US 2019/0316268 A1
(43) Pub. Date: Oct. 17, 2019

(54) METHOD OF PLATING A METALLIC SUBSTRATE TO ACHIEVE A DESIRED SURFACE COARSENESS

(71) Applicant: IH IP Holdings Limited, St. Helier (JE)

(72) Inventor: Dennis G. Letts, Austin, TX (US)

(21) Appl. No.: 16/343,433

(22) PCT Filed: Oct. 20, 2017
(86) PCT No.: PCT/US17/57509

§ 371 Date: Apr. 19, 2019

Related U.S. Application Data
(60) Provisional application No. 62/410,447, filed on Oct. 20, 2016.

(51) Int. Cl. C25D 5/16; C25D 3/50; C25D 5/36; C25D 5/00; B32B 15/01; B32B 15/18; C25D 5/18; C25D 3/48; C25D 3/56; C25D 5/10; C25D 21/12; C25D 7/04; G01B 11/30

(52) U.S. Cl. CPC C25D 5/16; C25D 3/50; C25D 5/36; C25D 5/006; B32B 15/018; B32B 15/18; G01B 11/303; C25D 3/48; C25D 3/567; C25D 5/10; C25D 21/12; C25D 7/04; C25D 5/18

(57) ABSTRACT

A method of plating a metallic substrate to achieve a desired surface coarseness includes: plating a metallic substrate with a source metal using a plating solution containing the source metal to produce a plated layer; and during said plating, varying at least one of multiple plating parameters to achieve a value of a coarseness metric of a surface of the plated layer above a minimum predetermined target value of the coarseness metric. Determining a value of a coarseness metric of a plated layer on a metallic substrate includes obtaining a magnified image of a surface of a plated layer recorded by a magnification device; identifying a path across the magnified image that crosses a plurality of pixels; and determining a contrast among the plurality of pixels.

### CROSS-REFERENCE TO RELATED APPLICATION

This application s a U.S. National Stage application of International Application No. PCT/US17/057509, filed on Oct. 20, 2017, which claims priority to U.S. Provisional Patent Application No. 62/410,447, titled “METHOD OF PLATING A METALLIC SUBSTRATE TO ACHIEVE A DESIRED SURFACE COARSENESS,” filed on Oct. 20, 2016, which is incorporated herein in its entirety by this reference.

### FIELD

The present disclosure relates to plating, and more particularly to a method of plating a metallic substrate to achieve a desired surface coarseness.

### BACKGROUND

An electrochemical co-deposition plating method involves concurrently plating a metallic substrate with a metal and loading heavy hydrogen (e.g., deuterium) into the coating. Such co-deposition is performed in an aqueous environment at temperatures of 60° to 80 C.

### SUMMARY

One example embodiment of a method of plating a metallic substrate to achieve a desired surface coarseness includes plating the metallic substrate using a plating solution containing a source metal that is capable of being deposited during the plating onto the metallic substrate over a range of surface coarseness from a first, minimum surface coarseness to a second, higher surface coarseness. Plating parameters used during the plating are adjusted to achieve a third surface coarseness of the source metal on the metallic substrate that is higher than the minimum surface coarseness.

In at least one embodiment, a method of plating a metallic substrate to achieve a desired surface coarseness includes: plating a metallic substrate with a source metal using a plating solution containing the source metal to produce a plated layer; and during said plating, varying at least one of multiple plating parameters to achieve a value of a coarseness metric of a surface of the plated layer above a minimum predetermined target value of the coarseness metric.

Varied plating parameters may include an electrical current applied to the plating solution, a voltage applied to the plating solution, and a temperature of the plating solution.

Varying at least one of the multiple plating parameters may include varying the electrical current applied to the plating solution by applying a first electrical current to a first portion of the plating solution during a first time period, and applying a second electrical current to the first portion or an additional second portion of the plating solution during a subsequent second time period, wherein the second electrical current is higher than the first electrical current.

The second electrical current may be at least 80% higher than the first electrical current.

Plating the metallic substrate may include applying an electrical current of approximately 1-2 amps to the plating solution.

In at least one example, approximately 5% of the volume of the plating solution includes at least one plating compound containing the source metal, the source metal comprising a different metal than the metallic substrate.

The source metal may include at least one hydride-forming metal.

The source metal may include palladium and at least one of lithium and lanthanum.

The metallic substrate may be an inner surface of a reactor.

A magnetic field may be applied from at least one magnet to the metallic substrate during the plating. For example, the magnetic field may have a magnetic flux density of at least 200 gauss.

A bonding may be deposited layer onto the metallic substrate, wherein the plated layer includes the source metal plated onto the bonding layer.

In at least one example, the plated layer includes the source metal and has a thickness facilitating an exothermic thermal activity. The thickness may be approximately 1-20 microns. The thickness may be approximately 5-15 microns.

The method may include loading a lattice structure of the plated layer with atoms of a gas after said plating is complete. The gas may include at least one of hydrogen, hydrogen isotopes, and a combination thereof. The loading may be performed when a temperature of the plated layer is above 100° C.

A voltage may be applied to the plated layer during the loading.

The loading may be performed until a hydrogen-to-source metal ratio of at least 85% is achieved for the plated layer.

The loading may include pressurizing the gas against the plated layer.

The value of the coarseness metric of the surface of the plated layer may be determined.

For example, the value of the coarseness metric of the surface of the plated layer may be determined by: obtaining a magnified image of the surface of the plated layer recorded by a magnification device; identifying a path across the magnified image that crosses a plurality of pixels; and determining a contrast among the plurality of pixels.

Determining a contrast among the plurality of pixels may include determining an intensity metric of each of the plurality of pixels, and comparing the determined intensity metrics.

According to at least one embodiment, determining a value of a coarseness metric of a plated layer on a metallic substrate includes obtaining a magnified image of a surface of a plated layer recorded by a magnification device; identifying a path across the magnified image that crosses a plurality of pixels; and determining a contrast among the plurality of pixels.

Determining a contrast among the plurality of pixels includes determining an intensity metric of each of the plurality of pixels, and comparing the determined intensity metrics.

The coarseness metric may be proportional to differences between intensity metrics of neighboring pixels. A graph of the intensity metrics may be created. The path across the magnified image may include a line across the image.

### BRIEF DESCRIPTION OF THE DRAWINGS

The disclosure can be further understood by reference to the following detailed description when considered in connection with these accompanying drawings.

FIG. 1 is a flowchart of an example method of plating a metallic substrate.

FIG. 2 schematically illustrates an example plating configuration.

FIG. 3 is a flowchart of an example method of determining a coarseness of a plated metallic surface.

FIG. 4A is a magnified image of an example plated metallic substrate.

FIG. 4B illustrates a roughness profile of the microscopic image of FIG. 4A.

FIG. 5A is a magnified image of another example plated metallic substrate.

FIG. 5B illustrates a roughness profile of the magnified image of FIG. 5A.

FIG. 6 schematically illustrates a computing device configured to perform the method of FIG. 3.

### DETAILED DESCRIPTION

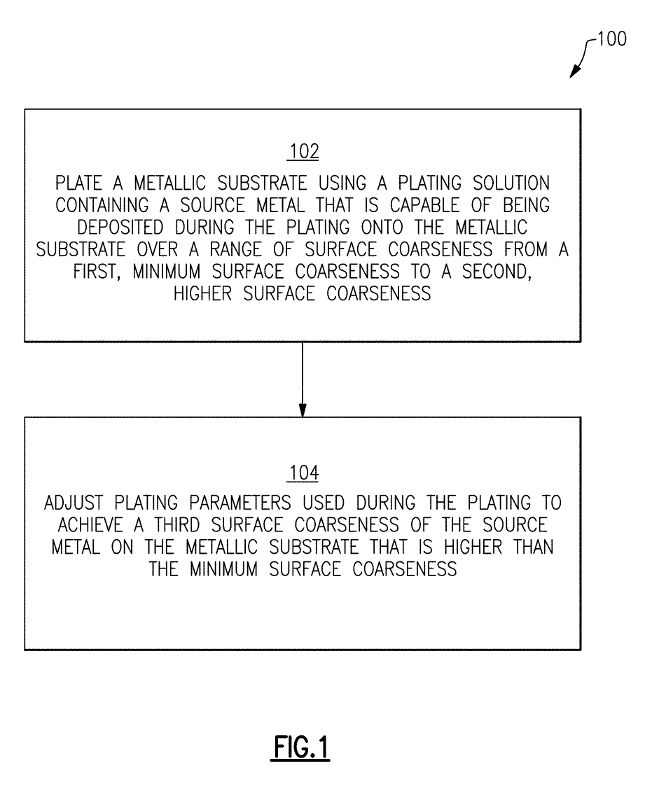

FIG. 1 is a flowchart of an example method 100 of plating a metallic substrate to achieve a desired, intermediate surface coarseness. Plating for industrial and aesthetic purposes produces smooth plated surfaces. Indeed, overly rough or coarse surfaces would be considered defective or unacceptable. As will be described, the method 100 involves the purposeful adjustment of plating parameters to achieve a coarse plating.

In the method 100, the metallic substrate is plated using a plating solution containing a source metal that is capable of being deposited during the plating onto the metallic substrate over a range of surface coarseness from a first, minimum surface coarseness to a second, higher surface coarseness (block 102). Plating parameters used during the plating are adjusted to achieve a third surface coarseness of the source metal on the metallic substrate that is higher than the minimum surface coarseness (block 104).

The source metal includes at least one hydride-forming metal. For example, the source metal includes either a single hydride-forming metal or multiple hydride-forming metals. In some embodiments, the source metal is selected from palladium, lithium, lanthanum, and combinations thereof. In a further example, the source metal is palladium, or is primarily palladium mixed with lithium and/or lanthanum. The at least one hydride-forming source metal may be present in the plating solution in the form of a metallic salt, such as but not limited to chloride salts (e.g., palladium chloride, lithium chloride, lanthanum chloride). In one example, the salt or other source metal or metal compound is approximately 3-7% of the volume of the plating solution, wherein the source metal is a different metal or metals than the metallic substrate. In one particular embodiment, the plating solution contains approximately 5% by volume of the salt, and other source metal, or metal compound.

In one example embodiment, the plating parameters that are adjusted include the electrical current applied to the plating solution, a voltage applied to the plating solution, and a temperature of the plating solution (which can serve as an approximation of the temperature of the metallic substrate, for example). By adjusting plating parameters, such as current, voltage, and temperature, during the plating of method 100, a desired intermediate coarseness of the plating can be achieved.

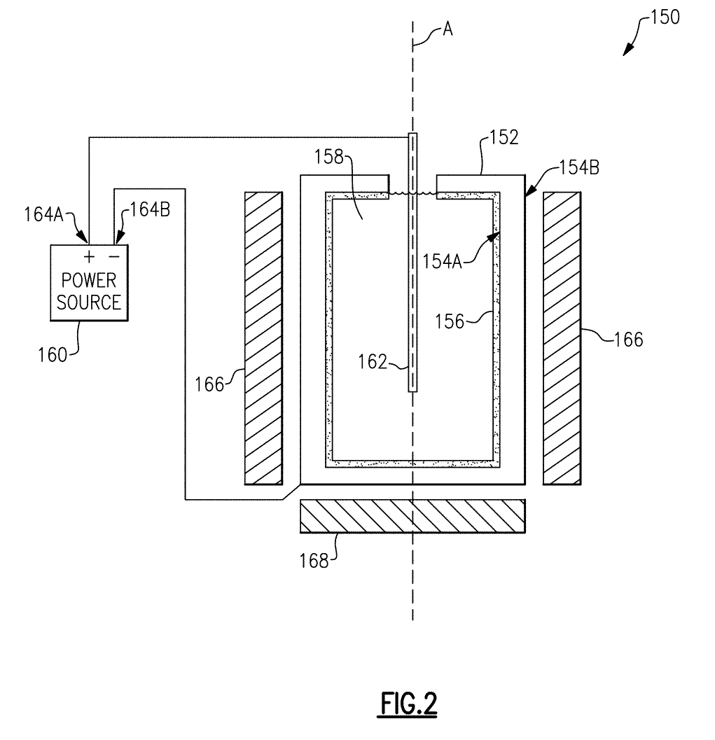

FIG. 2 schematically illustrates an example plating configuration 150 that may be used to perform the method 100. The metallic substrate to be plated in FIG. 2 is a container 152 that has an inner surface 154A and an outer surface 154B. The container 152 may be composed of 316L stainless steel, for example. Of course, it is understood that the container and/or its metallic substrate could alternatively be composed of a different steel alloy or other alloy. A bonding layer 156 (e.g., of gold or silver) may be situated on the inner surface 154A. The container 152 is filled with a plating solution. The plating solution may be an aqueous solution that contains the source metal (e.g., palladium, lithium, and/or lanthanum) to be plated onto the bonding layer 156. A power source 160 is used to electroplate the source metal from plating solution 158 onto the bonding layer 156.

In the example of FIG. 2, an anode 162 is connected to a positive terminal 164A of power source 160 and is situated along a central axis A of the container 152. In one example, the anode 162 is platinum. The anode 162 may be a wire or a conductive rod, for example. A negative terminal 164B of the power source 160 is connected to the container 152. In this example, the body of container 152 is configured as a cathode.

The power source 160 establishes a voltage across the plating solution 168 between the anode 162 and the container 152, which causes an electrical current to flow between the anode 162 and container 152. The electric current causes ions of the source metal to travel towards the inner surface 154A and deposit on the bonding layer 156. Additional amounts of the plating solution 158 may be added to the container 152 during plating, to replenish the source metal that is plated, and to ensure a desired thickness of the source metal is deposited onto the inner surface 154A of the container 152. The plating parameters used during the plating process can be adjusted to achieve a desired surface coarseness of the source metal.

One parameter that is controlled is the electric current through the plating solution 158 (i.e., current density). For example, the electrical current applied to the plating solution 158 may be approximately 1-2 amperes. In one particular embodiment, the adjusting of plating parameters includes applying a first, lower electrical current (e.g., 1 ampere) to the plating solution 158 during a first time period, and applying a second, higher electrical current (e.g., 2 amperes) during a subsequent second time period. In one example, the second electrical current is at least 80% greater than the first electrical current. For instance, if the first electric current is one ampere, the second is at least 1.8 amperes. Most typically, the second electric current is not more than five times greater than the first electric current.

In one example of the above described embodiment, a plurality of plating cycles are performed as part of the plating of block 102, with additional amounts of the source metal being added to the plating solution 158 for each cycle (e.g., 4 grams of a plating solution concentrate which contains approximately 5% by volume of source metal). The first, lower electrical current is used during initial plating cycles (e.g., three initial plating cycles), and the second, higher electrical current is used during a final plating cycle (e.g., a fourth plating cycle). The plating cycles may be repeated until a desired amount of source metal is plated onto the metallic substrate (e.g., approximately 0.5 grams). By increasing a voltage applied to the plating solution 158 during a fourth or last plating cycle or cycles, a greater coarseness can be achieved during the one or more later plating cycles.

The appearance of the plating solution 158 changing from an initial colored state (e.g., having an amber color) to a clear or less colored state may be used as an indication that the plating solution 158 has been depleted and that more plating solution 158 should be added to the container 152. In one example, the volume of the plating solution 158 in the container 152 is approximately 70 mL.

In one particular example, the first 2 grams of plating solution (which includes 5% by volume of palladium chloride) are added to approximately 70 grams of H₂O or D₂O and are electrolyzed at 1 amp until the plating solution is clear (or substantially clear). Then, 2 additional grams of plating solution are added and current is increased to 2 amps until the plating solution is clear (or substantially clear), which indicates that all of the metal has been plated to the cathode surface. This may be repeated, by adding additional amounts of plating solution and electrolyzing until the total amount of metal plated onto the metallic substrate has reached a predetermined value, such as 0.5 g.

During the plating of block 102, one or more magnets 166 may be situated outside of the container 152. In one example, a magnetic field provided by the one or more magnets 166 has a magnetic flux density of at least 200 gauss. In one particular embodiment, the magnetic field has a magnetic flux density of 250 gauss. In one embodiment, the at least one magnet 166 includes two half-cylindrical magnets that extend parallel to the axis A and substantially longitudinally surround the container 152. Additionally, the container 152 may be heated during the plating of block 102 through a heating device 168.

Prior to the plating of block 102, the bonding layer 156 may be deposited onto the metallic substrate of the container 152. The bonding layer 156 may include at least one of gold or silver, for example. To improve adhesion of the bonding layer 156 to the container 152, the container 152 may be roughened (e.g., by chemically etching the inner surface 154A of the container 152 with an activator solution and/or by abrading the inner surface 154A of the container 152 with sandpaper or a wire brush). The bonding layer 156 may be deposited onto the metallic substrate using a different plating solution than the one used in block 102 (e.g., a non-cyanide gold plating solution), or may be deposited using another deposition technique. In one example, a thickness of the bonding layer 156 is approximately 1-20 microns. In one particular embodiment, the thickness of the bonding layer 156 is approximately 5-15 microns. In one example, a mass of the bonding layer 156 is typically less than or equal to 0.5 g of gold or silver.

In one example the gold plating is performed for at least 10 minutes with a DC voltage of approximately 3-5 volts, at a current of approximately 0.25-0.5 amperes, and is performed at a temperature of approximately 60° C. After the gold plating is complete, the container 152 is rinsed thoroughly (e.g., using water) and dried (e.g., using a heat gun).

In one example, the container 152 is a cylindrical reactor that is operable to provide thermal energy through exothermic reactions, and a thickness of the source metal that is plated onto the inner surface 154A facilitates an exothermic thermal activity of the reactor. Of course, it is understood that this is only an example, and that other types of components could be plated using the technique described above.

Optionally, the magnets 166 and/or heating device 168 may be situated within a calorimeter enclosure (not shown) that at least partially surrounds the container 152. In such embodiments, the calorimeter could also be used to take heat measurements during the plating of block 102.

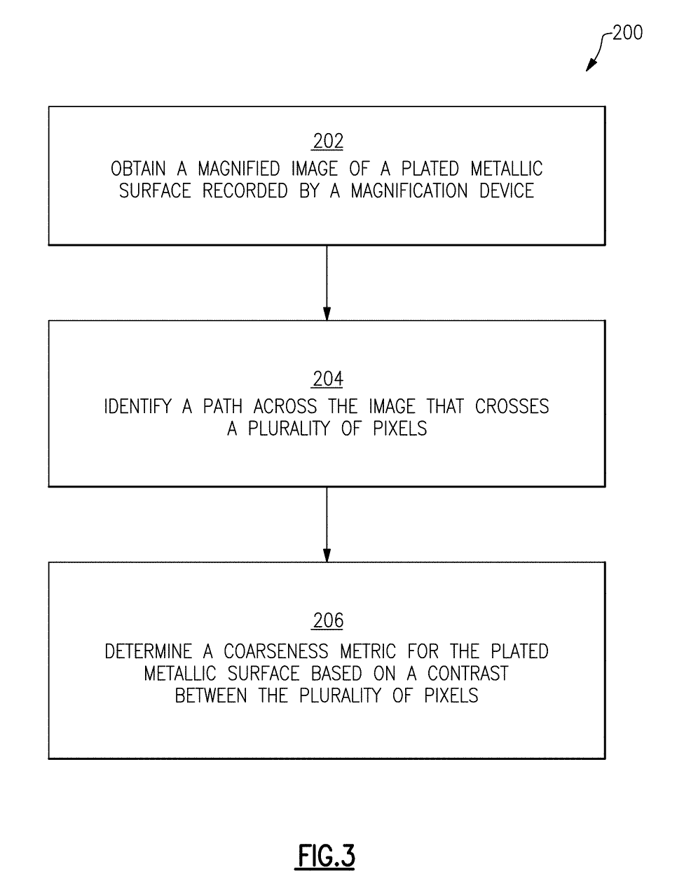

FIG. 3 is a flowchart of an example method 200 of determining a coarseness of a plated metallic surface (e.g., inner surface 154A of container 152 after the plating method 100 is complete). At block 202 a magnification device (e.g., a microscope or a borescope) is used to obtain a magnified image of the plated metallic surface. The image is recorded and a line is superimposed across the image that crosses a plurality of pixels (block 204). A coarseness metric is determined for the plated metallic surface based on a contrast between the plurality of pixels (block 206). In one example embodiment, the coarseness metric is proportional to differences between intensity metrics of neighboring pixels. In one example embodiment, contrast may be measured by a difference between the intensity of two neighboring pixels.

The method 200 can be used to determine a surface coarseness of a metallic substrate plated using the method 100, for example. Put another way, the intensity of each pixel represents how much light is reflected by the plated metallic surface at that pixel, and correspondingly represents a surface depth at that location on the image, such that in total the intensities correspond to or replicate the surface coarseness. In some embodiments, the intensity metrics of the pixels are brightness values (e.g., pixel intensities on a scale of 0-255 where 0 is black and 255 is white).

In one example, the determining of block 206 includes determining an intensity metric of each of the plurality of pixels crossed by the superimposed line, and the determining of the overall coarseness metric is performed based on the plurality of intensity metrics. In some embodiments, the method 200 includes creating a graph of the intensity metrics.

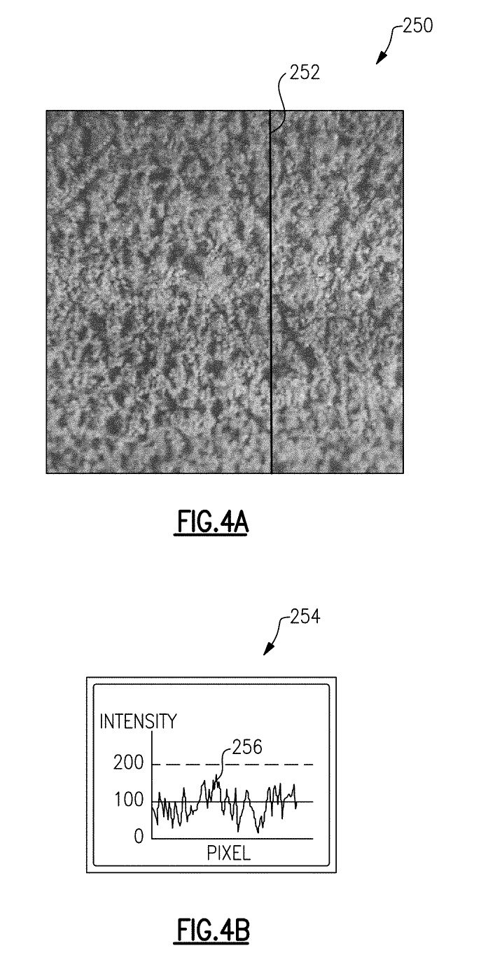

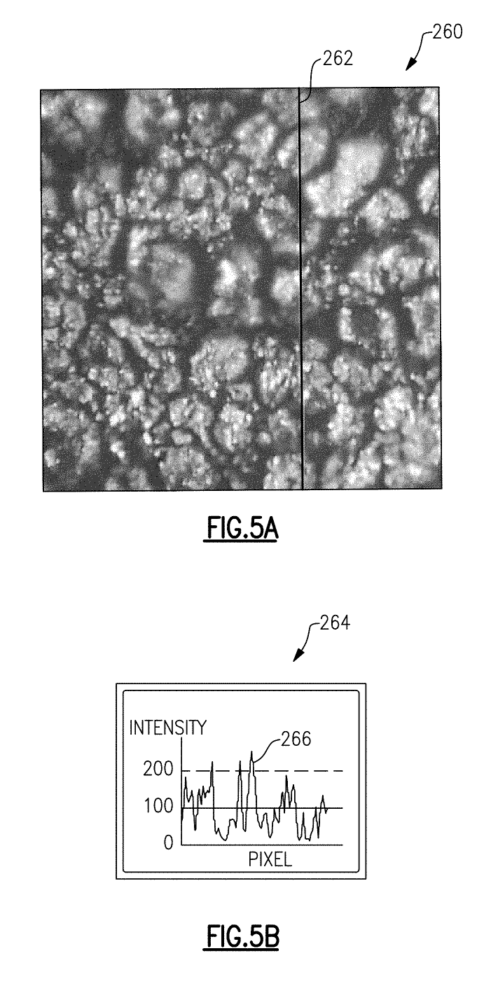

FIGS. 4A-B and 5A-B illustrate examples of how the method 200 may be performed. FIG. 4A is a magnified image 250 of a first example plated metallic substrate that has been plated with pure palladium, and FIG. 5A is a magnified image 260 of a second example plated metallic substrate that has been plated with palladium-lanthanum. Each image 250, 260 has a respective superimposed line 252, 262, and each of the lines 252, 262 crosses a plurality of pixels.

FIG. 4B is a graph 254 that displays a roughness profile 256 of the pixels along line 252 of image 250, and FIG. 5B is a graph 264 that displays a roughness profile 266 of the pixels along line 262 of image 260. Each of the roughness profiles 256, 266 are centered approximately around a pixel intensity of 100, but the roughness profile 266 has a greater variation in pixel intensity values than the profile 256, indicating that the palladium-lanthanum plating of FIG. 5A has a greater surface coarseness than the pure palladium plating of FIG. 4A.

In particular, the roughness profile 256 of FIG. 4B has a highest intensity value of approximately 150, and a lowest intensity value of approximately 20, yielding an intensity ratio of approximately 7.5 to 1, and a maximum differential of approximately 130 units. In the roughness profile 266 of FIG. 5B, the highest intensity value is approximately 250, and the lowest intensity value is approximately 20, yielding an intensity ratio of approximately 12.5 to 1, and a maximum differential of approximately 230 units. The greater ratio and differential of FIG. 5B indicates that the plating of FIG. 5A has a greater surface coarseness than the plating of FIG. 4A.

A respective overall coarseness metric value can be determined for each of the images 250, 260 based on the distribution of pixel intensity values (e.g., an average or median value along with an indication of maximum and minimum values in the distribution, a weighted difference between a subset of highest pixel intensity values and a subset of lowest pixel intensity values, etc.). Optionally, a statistical analysis can be performed and the coarseness metric value could be based on the standard deviation between intensity metrics of the plurality of pixels of a given image.

A cosmetically appealing metal (e.g., a piece of jewelry that is plated with palladium) will be very smooth and will have an intensity variation of around 10 units. A surface designed to maximize exothermic reactions (such as a reactor), by contrast, may be very rough and may have an intensity variation of 100-250 units (e.g., as shown in FIGS. 5A-B). In some embodiments, the “intermediate surface coarseness” discussed above in connection with the method 100 of FIG. 1 includes a variation of 100-200 units. In further examples, the intermediate surface coarseness includes a variation of 125-225 units.

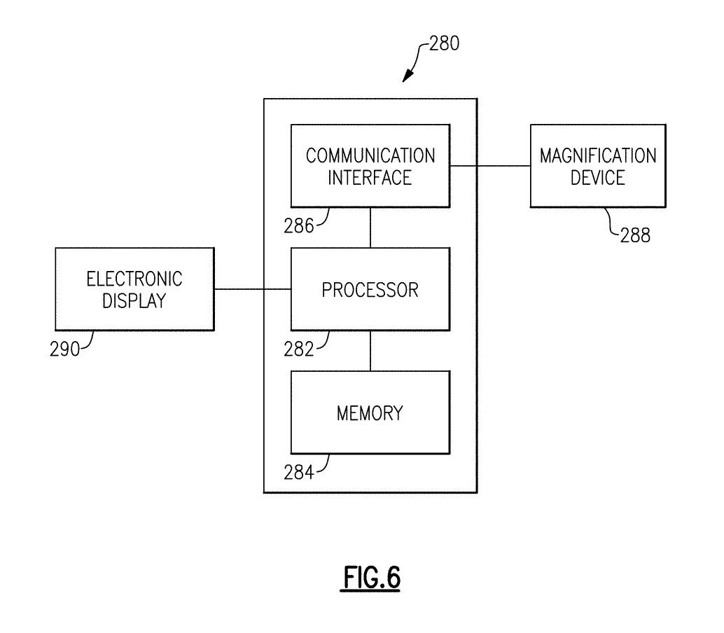

FIG. 6 schematically illustrates a computing device 280 configured to perform the method 200 of FIG. 3. The computing device 280 includes a processor 282 that comprises hardware, such as one or more processing circuits that may include one or more microprocessors, microcontrollers, application specific integrated circuits (ASICs), or the like, for example. The computing device 280 also includes memory 284, which may include one or several types of memory such as read-only memory (ROM), random-access memory, cache memory, flash memory devices, optical storage devices, etc. The memory 284 stores program instructions that, when executed by processor 282, configure the computing device 280 to perform the method 200.

A communication interface 286 is configured to facilitate communication with other devices, such as magnification device 288 (e.g., a microscope or borescope) that is operable to record images of plated metallic substrates. The communication interface 286 may provide a wired or wireless connection, for example. The processor 282 is operatively connected to both the memory 284 and the communication interface 286, and is further operatively connected to an electronic display 290 for displaying images such as images 250, 260 and graphs 254, 264.

Referring again to FIG. 1, after the plating of block 102 is complete, a lattice structure of the interior of the container 152 may be loaded with atoms of a gas to produce a thermally reactive surface. For example, the gas may include hydrogen, hydrogen isotopes (e.g., deuterium), or a combination thereof. It is contemplated that the atoms of hydrogen or deuterium enter the lattice structure of the metallic substrate, and occupy octahedral positions within the lattice structure of the absorbing metal. As vacancies become available, it is contemplated that the gas atoms occupy the vacancies where the heat-producing reactions are thought to occur.

As part of the loading, the gas is pressurized against the inner surface 154A of the container 152 at one or more predetermined pressures and one or more predetermined temperatures. Prior to the loading, the interior of the container 152 may be rinsed and dried and then pumped to vacuum.

A current and voltage may be applied to the gas within the container 152 during the loading (e.g., 1-200 mA at DC voltages ranging from 100 to 5000 volts), while the container 152 is heated to a temperature that may be above 100° C. (e.g., 140°-150° C). In one example, the loading is performed until a hydrogen-to-source metal ratio of at least 85% is achieved for the plated metallic substrate (e.g., a ratio of 0.85 of deuterium to palladium). The loading may be performed over a relatively extended period of time (e.g., on the order of four days). Magnets may optionally be used during the loading as well to provide a magnetic field within the container 152 to facilitate driving atoms into the plated inner surface 154A of the container 152.

The techniques described above, through which plating and hydrogen loading are performed separately, can be performed at a higher operating temperature than would be possible with the co-deposition technique of the prior art, which required operating temperatures to remain in the range of 60°-80° C. The separate plating and loading permit each to be better tailored to the objective of forming a reactive plated surface without being bound by the limitations of co-deposition. The surface coarseness is thought to reflect weakened interatomic bonding in the plated metal, such that a higher concentration of vacancies can be achieved. Also, the separate loading can be performed at a higher temperature than in co-deposition, and higher temperatures facilitate better loading and a higher concentration of vacancies in the plated metal. If the item being plated and loaded is a reactor, separately performed plating and loading may be more suitable to the higher operating temperature requirements of the reactor. Additionally, by separately performing the plating of method 100 and the loading of atoms into a lattice structure of the metallic substrate, the loading can be performed in a non-aqueous environment.

Rough surfaces, such as the one shown in FIG. 5A, are believed to have lower vacancy formation energies (VFEs) than smooth surfaces. A low VFE will produce a higher concentration of vacancies in a plated deposit, which could be beneficial if the metallic substrate being plated is an interior of a reactor, because higher VFEs are believed to produce more intense exothermic reactions in a plated metal surface. The adjusting of block 104 of method 100 may be performed to achieve a surface coarseness that exhibits a desired concentration of vacancies.

Although example embodiments have been disclosed, a worker of ordinary skill in this art would recognize that certain modifications would come within the scope of the claims. For that reason, the following claims should be studied to determine their true scope and content.

1. A method of plating a metallic substrate to achieve a desired surface coarseness, the method comprising:
plating a metallic substrate with a source metal using a plating solution containing the source metal to produce a plated layer; and
during said plating, varying at least one of multiple plating parameters to achieve a value of a coarseness metric of a surface of the plated layer above a minimum predetermined target value of the coarseness metric.

2. The method of claim 1, wherein varying at least one of multiple plating parameters comprises varying at least one of an electrical current applied to the plating solution, a voltage applied to the plating solution, and a temperature of the plating solution.

3. The method of claim 2, wherein varying at least one of the multiple plating parameters comprises varying the electrical current applied to the plating solution by applying a first electrical current to a first portion of the plating solution during a first time period, and applying a second electrical current to the first portion or an additional second portion of the plating solution during a subsequent second time period, wherein the second electrical current is higher than the first electrical current.

4. (canceled)

5. The method of claim 1, wherein plating the metallic substrate comprises applying an electrical current of approximately 1-2 amps to the plating solution.

6. The method of claim 1, wherein the plating solution has a volume, and wherein approximately 5% of the volume comprises at least one plating compound containing the source metal, the source metal comprising a different metal than the metallic substrate.

7. The method of claim 1, wherein the source metal comprises at least one hydride-forming metal, or palladium and at least one of lithium and lanthanum.

8. (canceled)

9. The method of claim 1, wherein the metallic substrate comprises an inner surface of a reactor.

10. The method of claim 9, further comprising applying a magnetic field from at least one magnet to the metallic substrate during the plating.

11. (canceled)

12. The method of claim 1, further comprising, prior to said plating, depositing a bonding layer onto the metallic substrate, wherein the plated layer comprises the source metal plated onto the bonding layer.

13. The method of claim 1, wherein the plated layer comprises the source metal and has a thickness facilitating an exothermic thermal activity, wherein the thickness is approximately 1-20 microns, and optionally, wherein the thickness is approximately 5-15 microns.

14. (canceled)

15. The method of claim 1, further comprising loading a lattice structure of the plated layer with atoms of a gas after said plating is complete, wherein the gas comprises at least one of hydrogen, hydrogen isotopes, and a combination thereof.

16. (canceled)

17. The method of claim 11, wherein the loading is performed when a temperature of the plated layer is above 100° C.

18. The method of claim 11, further comprising applying a voltage to the plated layer during the loading.

19. (canceled)

20. The method of claim 11, wherein the loading comprises pressurizing the gas against the plated layer.

21. The method of claim 1, further comprising determining the value of the coarseness metric of the surface of the plated layer, wherein determining the value of the coarseness metric of the surface of the plated layer comprises:
obtaining a magnified image of the surface of the plated layer recorded by a magnification device;
identifying a path across the magnified image that crosses a plurality of pixels; and determining a contrast among the plurality of pixels.

22-28. (canceled)
